(19) United States
(12) Patent Application Publication
(10) Pub. No.: US 2016/0179676 A1
(43) Pub. Date: Jun. 23, 2016

(54) CLEANING A WRITE-BACK CACHE

(71) Applicant: ARM LIMITED, Cambridge (GB)

(72) Inventors: Andreas Due ENGH-HALSTVEDT, Trondheim (NO); Jørn NYSTAD, Trondheim (NO)

(21) Appl. No.: 14/957,117

(22) Filed: Dec. 2, 2015

(30) Foreign Application Priority Data
Dec. 19, 2014 (GB) 1422789.6

(51) Int. Cl. G06F 12/08

(52) U.S. Cl. CPC G06F 12/0833; G06F 12/0804; G06F 2212/621

(57) ABSTRACT

A data processing system incorporates a write-back cache and supports load-and-clean program instructions. The action of a load-and-clean program instruction is to load a data value and to mark as clean at least a target portion within a cache line of the write-back cache which is storing the data value loaded. The data values to be subject to such load-and-clean instructions may be identified by the programmer as the last use of those data values, or may be identified by a compiler as the last use of those data values. The data values may be from a stack memory region in which their pattern of access is predictable and it is known when they are no longer required. Another example of regular memory accesses where the last access can be identified is when processing streaming media data.

### BACKGROUND

1. Field

This invention relates to the field of data processing systems.

2. Description

It is known to provide data processing systems with cache memories in order to provide lower latency access to frequently used or critical data or instructions. One known type of cache memory is a write-back cache memory. Data may be written to a write-back cache memory without other versions of that data, such as held in the main memory, being updated until the data which has been written (the dirty data) is evicted from the write-back cache.

In accordance with at least some example embodiments of the disclosure, there is provided apparatus for processing data comprising:

a write-back cache having a plurality of cache lines;

processing circuitry to perform processing operations specified by program instructions; and

an instruction decoder to decode a load-and-clean instruction to generate control signals:
to control said processing circuitry to load data from a target portion of a target cache line; and
to control said write-back cache to mark as clean at least said target portion of said target cache line.

### SUMMARY

In accordance with at least some embodiments of the disclosure there is provided apparatus for processing data comprising:

write-back cache means for storing data said write-back cache means having a plurality of cache lines;

processing means for performing processing operations specified by program instructions; and

instruction decoding means for decoding a load-and-clean instruction to generate control signals:
to control said processing means to load data from a target portion of a target cache line; and
to control said write-back cache means to mark as clean at least said target portion of said target cache line.

In accordance with at least some embodiments of the disclosure there is provided a method of processing data comprising:

storing data within a write-back cache having a plurality of cache lines;

perform processing operations specified by program instructions; and

decoding a load-and-clean instruction to generate control signals:
to control loading data from a target portion of a target cache line; and
to control marking as clean at least said target portion of said target cache line.

In accordance with at least some embodiments of the disclosure there is provided a method of compiling a source program to generate an object program comprising:

identifying a last use within said source program of a data value stored at a memory address;

if said source program specifies loading a target data value that is a last use of said target data value, then generating a corresponding load-and-clean instruction within said object program; and

if said source program specifies loading a target data value that is not a last use of said target data value, then generating a corresponding load instruction within said object program.

Example embodiments will now be described, by way of example only, with reference to the accompanying drawings in which:

### DRAWINGS

FIG. 1 schematically illustrates a data processing system including a write-back cache;

FIG. 2 is a flow diagram schematically illustrating the processing of a load instruction using a write-back cache;

FIG. 3 schematically illustrates the operation of a load-and-clean instruction upon a cache line in accordance with a first example embodiment;

FIG. 4 schematically illustrates the operation of a load-and-clean instruction upon a cache line in accordance with a second example embodiment;

FIGS. 5 and 6 schematically illustrate the operation of a load-and-clean instruction from different portion within a cache line in accordance with a third example embodiment;

FIG. 7 is a flow diagram schematically illustrating a first example of eviction control;

FIG. 8 is a flow diagram schematically illustrating a second example of eviction control; and

FIGS. 9 and 10 are flow diagrams schematically illustrating compiling a source program to utilize load-and-clean instructions.

It is possible that programmer or compiler may identify that when a load is being performed of a data value from a memory address there will be no subsequent use of that data value in the program concerned. Examples of such situations include stack memories where data has been spilled to the stack memory upon a context change and is then POPed from the stack memory when the original context is resumed. In this case, the stack memory serves as temporary storage and once the data has been recovered, the data values stored within the memory address space which provided the temporary storage are no longer required. Another example would be use of a FIFO, circular buffer or other temporary buffer.

When a programmer or compiler has identified that a load will be the last one to be performed upon a data value at a given memory address location, then a load-and-clean instruction may be used for that final load operation in place of for example, a standard load instruction. The load-and-clean instruction controls a write-back cache which, may be storing the data value to be loaded, to mark that data value as clean after the load-and-clean instruction has been executed such that it no longer needs to be written back to the backing memory system. This saves memory bandwidth in writing back dirty data values which are no longer required and will not be used again. Marking the data as clean does not require the dirty data to be written out to the main memory as would be conventional with a full clean operation (write back and mark as clean).

It is possible that the write-back cache for which the load-and-clean instruction suppresses unnecessary write-back of dirty values may use cache lines which comprise a plurality of portions each having a dirty flag indicative of whether a respective portion has been written with data that has not yet been written back to a memory. As an example, per-byte dirty flags may be provided within each cache line.

In one example embodiment the write-back cache may respond to a load-and-clean instruction to change a dirty flag for at least the target portion of the cache line from which a load is being performed such that if the dirty flag for that target portion is set to “dirty”, then it is changed to he clean. It will he appreciated that the load-and-clean instruction may change a dirty flag for a target portion to clean or if the flag for the target portion already indicates that it is clean, then this will be left unchanged. It is possible that the target portion may have been written while it was stored within the write-back cache, but has already been subject to a clean operation, such as by virtue of eviction from and then reloading into the write-back cache.

In some embodiments the load-and-clean instruction may change a dirty flag for the target portion which indicates that the target portion is dirty to indicate that the target portion is clean whilst leaving unchanged any dirty flags for other portions of the target cache line. This type of behavior is suited to embodiments in which the data being cached may correspond to a general purpose buffer in which there is no particular pattern to the accesses to different portions of a cache line.

In other example embodiments, the data structure stored within the write-back cache may he one with a particular access pattern, such as a stack memory. In this case, it may be known that if a load-and-clean instruction is executed for a target portion within a cache line, then any other portions of that cache line within the region extending from the target portion to a predetermined end of the cache line (i.e. extending in a predetermined memory-address-order from the target portion) will also not be needed again and so can be marked as clean (any dirty flags set to clean, but without a write-hack needing to be performed). The portions of the cache line extending in the opposite direction to the pre-determined memory address order can have their dirty flags left unchanged.

In other example embodiments, it may be that extending the marking of portions of a cache line as clean when these do not encompass the entire cache line is of reduced benefit and accordingly operation may he simplified when, if the target portion is at a predetermined end of the target cache line, then any dirty flags for all portions of that target cache line are changed as necessary to clean, whereas, if the target portion is not at the predetermined end of the target cache line, then the dirty flags for portions other than the target portion are left unchanged. Such an embodiment still uses individual dirty flags for the different portions of a cache line.

In other embodiments, a plurality of portions of the target cache line may share a dirty flag and in some example embodiments a single dirty flag may be provided for a whole cache line. With such embodiments, the write-back cache may respond to a load-and-clean instruction if the target portion is at a predetermined end of the target cache line to change the dirty flag for the target cache line to indicate that the target cache line is clean and to suppress such action if the target portion is not at the predetermined end of the target cache line.

A feature of at least some example embodiments of the disclosure is that if a target portion for a load-and-clean instruction is marked as clean to avoid any subsequent unnecessary needed write-back, then the cache line containing that target portion remains in the write-back cache and so is available for further access operations, e.g. access operations to different portions of that cache line which are still required and still valid.

The write-back cache comprises cache line eviction circuitry which controls eviction of cache lines from the write-back cache, typically in accordance with one of many known eviction policies. This cache line eviction circuitry may also be responsive to execution of load-and-clean program instructions.

The manner in which the cache line eviction circuitry is responsive to execution of a load-and-clean program instruction can vary. In some example embodiments, when the execution of a load-and-clean program instruction results in all portions of the target cache line concerned being marked as clean, then this will serve to control the cache line eviction circuitry to promote that target cache line within an order for eviction make it the next eviction candidate. In other embodiments, the cache line eviction, e.g. circuitry may respond to execution of a load-and-clean program instruction, as distinct from other forms of memory access instructions, to suppress updating of least-recently-used data associated with that target cache line such that the load-and-clean program instruction will not have an influence upon how the cache line is treated for eviction based upon its least-recently-used data.

In some embodiments, in addition to having one or more dirty flags per cache line, a cache line may also include a valid flag indicative of whether that cache line contains any valid data.

While it will be appreciated that the techniques of the disclosure could he used in a wide variety of different forms of processing systems, they may find good utility in the context of processing circuitry which a FIFO and/or circular buffer for memory accesses and/or within a system using a graphics processing unit (which may typically have a predictable pattern of use of data held within a write-back cache such that the last use of that data can he identified and a load-and-clean instruction employed to suppress wasteful unnecessary write-back operations).

Another form of the present technique is the provision of a compiler to identify places with a program in which load-and-clean program instructions can usefully be employed. Compilers typically already track data value usage within program code for reasons other than associated with write-back from cache memories. Given that a compiler can relatively readily identify the last use of a data value within a program, then the compiler when generating a load instruction can determine if that load instruction is the last use of the data value concerned, and accordingly generate a load-and-clean instruction while otherwise generating a “normal” load instruction if the load is not the last use of the data value concerned.

### EMBODIMENTS

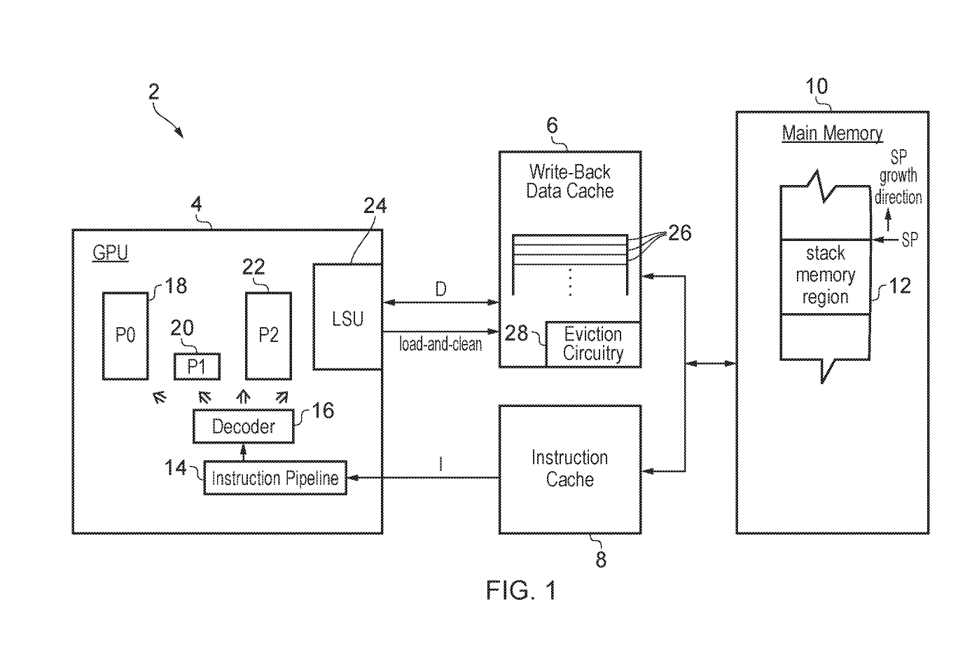

FIG. 1 schematically illustrates a data processing system 2 including a processor 4, in the form of a graphics processing unit, a write-back data cache 6, an instruction cache 8 and a main memory 10. The main memory 10 in this example stores a stack memory region 12 having a stack pointer SP indicating the memory address at which data values are to be added to the stack memory region or removed from the stack memory region. There is a stack pointer growth direction associated with the stack memory region 12 and this may be either ascending or descending depending upon the system concerned and/or the configuration of that system.

The processor 4 fetches instructions from the instruction cache 8 to an instruction pipeline 14. When the instructions reach a decode stage, then they are decoded by an instruction decoder 16 which generates control signals which control processing performed by a variety of processing pipelines 18, 20, 22 that include a load/store pipeline 24. The load/store pipeline 24 is responsible for handling memory access instructions including both load-and-clean instructions and standard load instructions.

The write-back data cache 6 includes a plurality of cache lines 26 which each store a plurality of portions of data, e.g. the write-back data cache 6 may support access granularity down to byte accesses and include per-byte dirty bits as well as a per-line valid bit. Eviction circuitry 28 within the write-back data cache serves to control cache line eviction using one of a variety of different eviction algorithms, such as least-recently-used, round-robin, random etc.

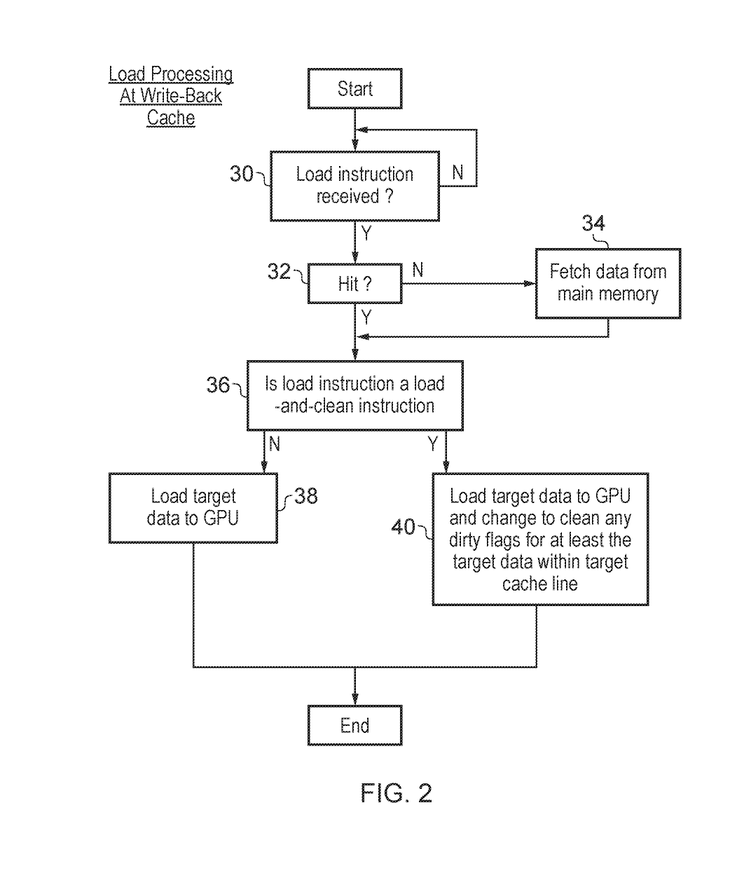

FIG. 2 schematically illustrates load processing at the write-back cache 6. At step 30 processing waits until a load instruction is received. Step 32 then determines whether or not the load instruction hits within the write-back cache data 6. If there is no hit, the step 34 serves to fetch the data from the memory 10 into the write-back data cache 6. Either following the fetch at step 34 or if there is a hit, processing proceeds to step 36 where the write-back data cache 6 determines whether or not the load instruction it has received is a load-and-clean instruction. If the instruction is not a load-and-clean instruction, then step 38 serves to load the target data to the processor it If the load instruction is a load-and-clean instruction, then step 40 serves to load the target data to the processor 4 and change to clean any dirty flags for at least the target data within the target cache line where the hit occurred. As will be described below, there are various alternatives in the way in which either the particular target portion of a cache line may be marked as clean or a more extended region of the target cache line.

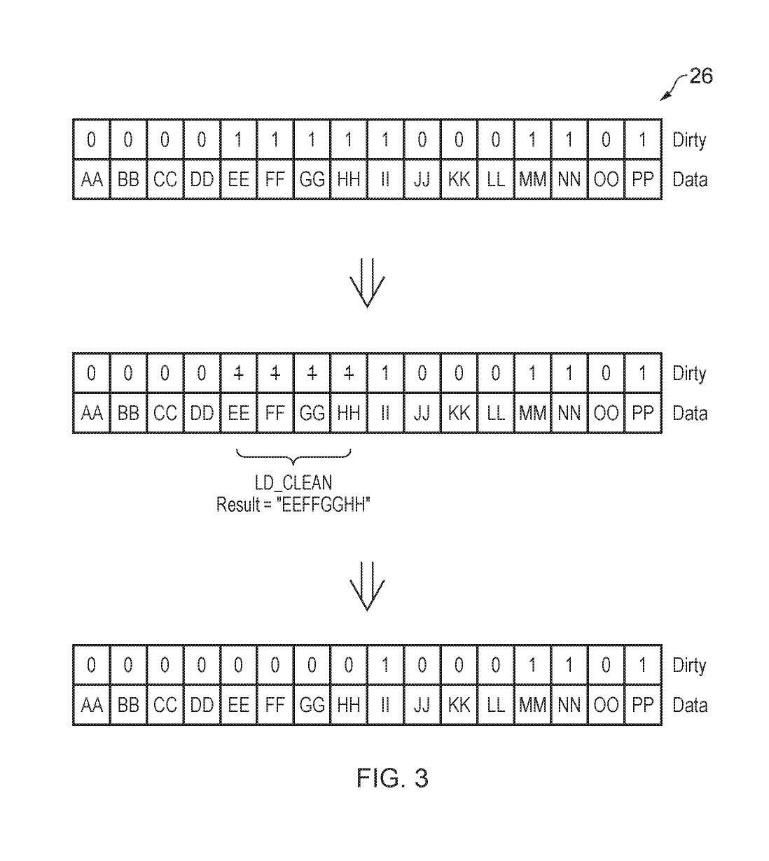

FIG. 3 schematically illustrates a cache line 26 storing data values with different portions of the cache line, each having an associated dirty flag. If the dirty flag has a value of “1”, then in this example embodiment this indicates that the corresponding portion of data within the target cache line is dirty (e.g. has been changed since it was fetched into the cache line and not yet written out to main memory). Conversely, if the dirty flag value for a portion is “0”, then this indicates that the data value of that portion is consistent with the corresponding data value in the memory 10. The cache line 26 illustrated in FIG. 3 is then subject to a load-and-clean instruction reading a target portion of the cache line 26 corresponding to the data values EEFFGGHH. The dirty flags for the four bytes which form this target portion were all previously set and the load-and-clean instruction serves to reset these as indicated in the bottom of FIG. 3. It will be appreciated that if any of the dirty flags for the target portion was not set, then it would be unchanged by the action of the load-and-clean instruction. Furthermore, it will be appreciated that the particular values that the flag has to indicate dirty status or clean status could be switched or the dirty status could be represented by a flag having a different form.

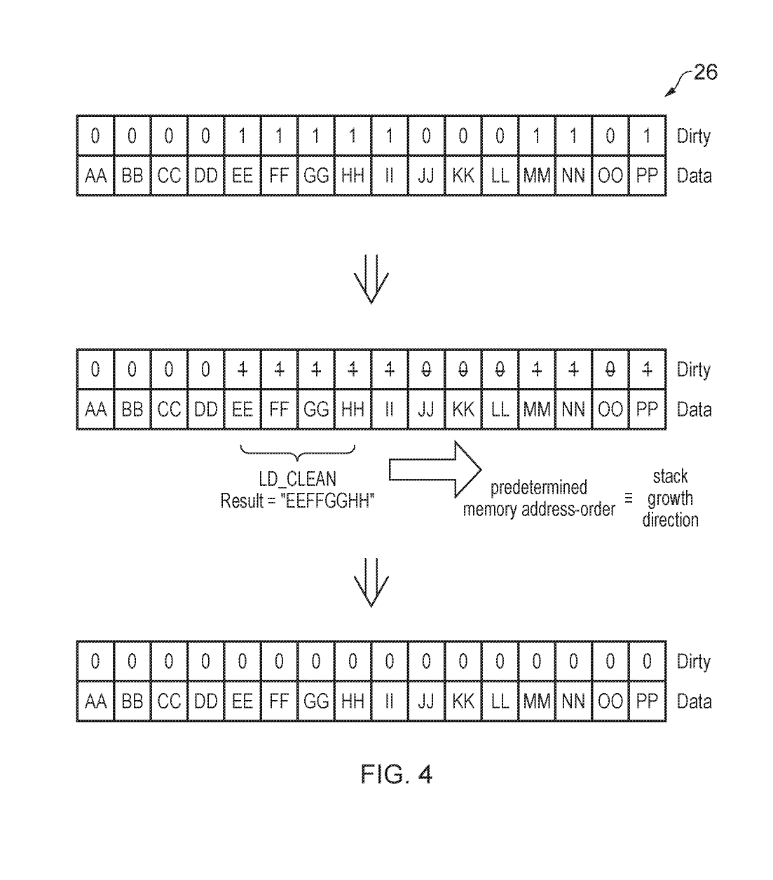

FIG. 4 illustrates a second example embodiment. In this example embodiment, the write-back data cache 6 responds to a load-and-clean instruction to the same target portion as for FIG. 3 by marking as clean that target portion and additionally marking as clean all of the target portions within that cache line extending in a predetermined memory-address-order from the target portion to an end of the cache line in that direction. The predetermined memory-address-order may correspond to the stack growth direction. The final line in FIG. 4 illustrates that, as a result of the modified behavior of the load-and-clean instruction in controlling the write-back data cache 6, the whole of the cache line 26 is now marked as clean. The predetermined memory-address-order (and the predetermined end referred to below) may be, for example, fixed for the system, set using a configuration parameter(s) for the system and/or selected via a field within the load-and-clean instruction itself, i.e. the instruction encoding specifies the direction.

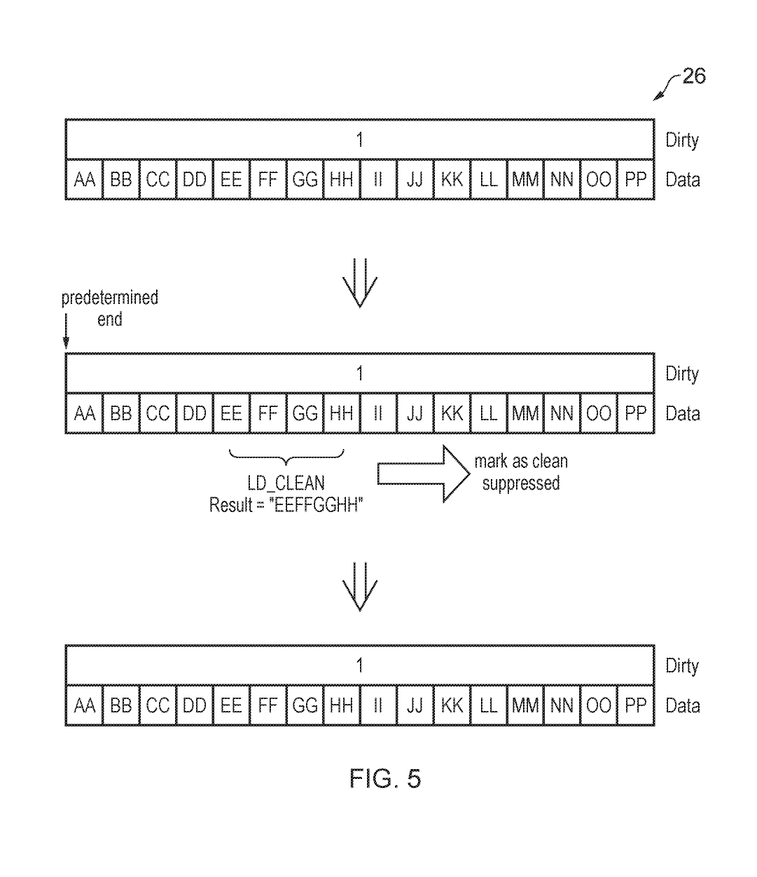

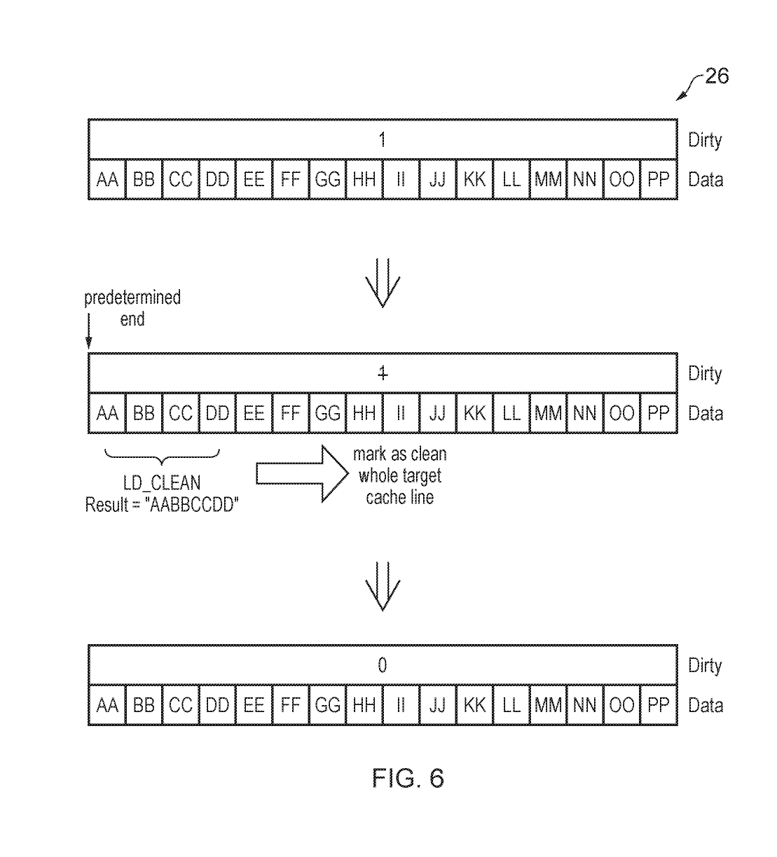

FIGS. 5 and 6 illustrates a third example way in which the write-back data cache 6 may respond to a load-and-clean instruction, in this example a single dirty flag is provided for the whole of the cache line 26. When the target portion subject to the load-and-clean instruction is not at a predetermined end of the cache line 26, then the action of marking the target cache line as clean is suppressed. Thus, as can be seen in FIG. 5, the target cache line 26 remains marked as dirty. In contrast, FIG. 6 illustrates the same example embodiment, but in this case with the target portion being at the predetermined end of the target cache line. In this case, the whole target cache line is marked as clean by changing the value of the dirty bit for that target cache line as shown.

It will be appreciated that the examples of FIGS. 3, 4, 5 and 6 are only some examples of the way in which a load-and-clean instruction may operate. The manner of operation of the load-and-clean instruction may be fixed for a particular implementation of a write-back cache (and optionally not visible to the programmer) or could possibly be set by parameters associated with the load-and-clean instruction, e.g. the compiler could identify When the data values are stack data values and use the load-and-clean instruction variant of FIG. 4 while using the load-and-clean instruction variant of FIG. 3 for situations in which the data values correspond to a more general purpose buffer.

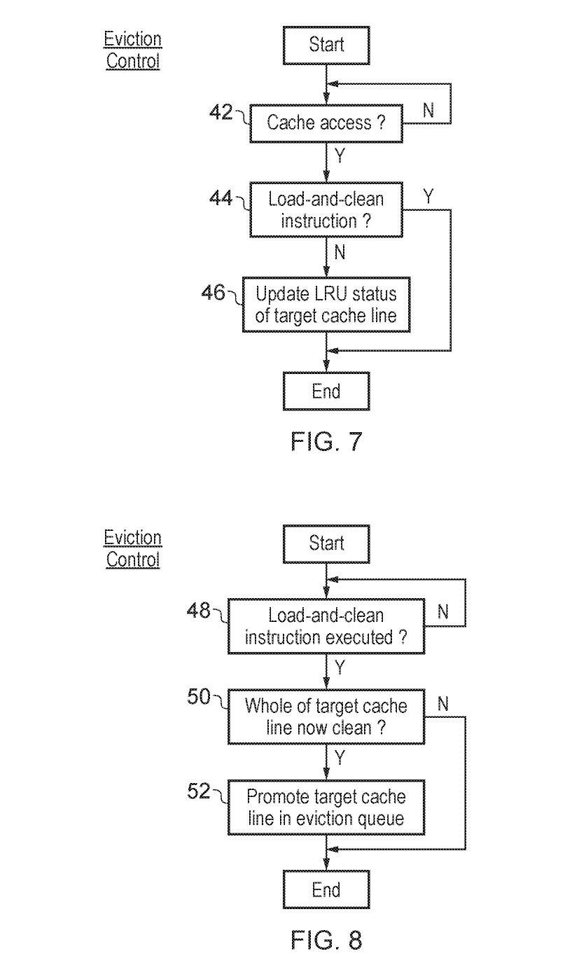

FIG. 7 illustrates a first example of how eviction control may be modified to operate with load-and-clean instructions. At step 42, processing waits until a stack access is performed. Step 44 then determines whether the cache access performed was a load-and-clean instruction. If the cache access was not a load-and-clean instruction, then step 46 serves to update the least recently used (LRU) status of the target cache line which has been accessed to indicate that it has been accessed. If the cache access was a load-and-clean instruction as identified at step 44, then step 46 is bypassed. The effect of bypassing the LRU status is that the cache line concerned will not be noted as having recently been being used and accordingly will be more likely to be evicted, This is consistent with the cache line having been marked as clean (at least partially).

FIG. 8 is a flow diagram schematically illustrating a second example of the way in which load-and-clean instructions may interact with eviction control from the write-back data cache 6. At step 48 processing waits until aloud-and-dean instruction is executed. Step 50 then determines whether the whole of the target cache line which has been subject to the load-and-clean instruction is now marked as clean. If the whole of the target cache line is marked as clean, then step 52 serves to promote that target cache line in the eviction queue (e.g. to the top of the queue, or at least higher in the likelihood of eviction). If the determination at step 50 is that the whole of the target cache line is not now clean, then step 52 is bypassed.

It will be appreciated that the processing illustrated in FIGS. 7 and 8 will be performed by the cache line eviction circuitry 28 of FIG. 1 as part of the eviction policy it is operating. A wide variety of different forms of eviction policy will be familiar to those in tins technical field.

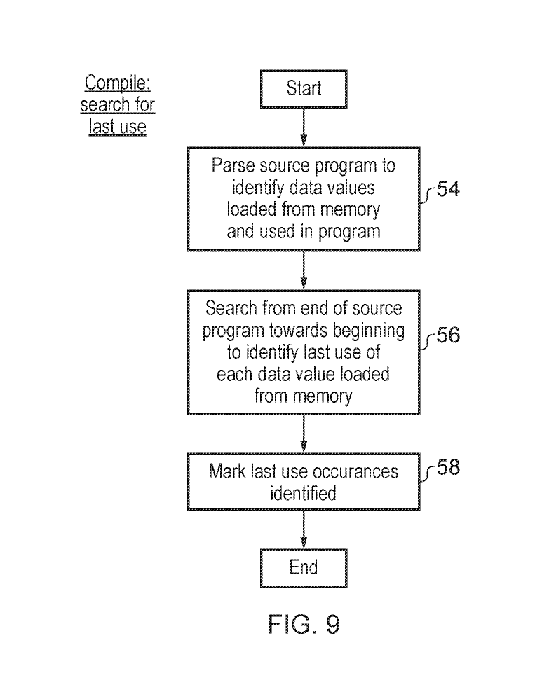

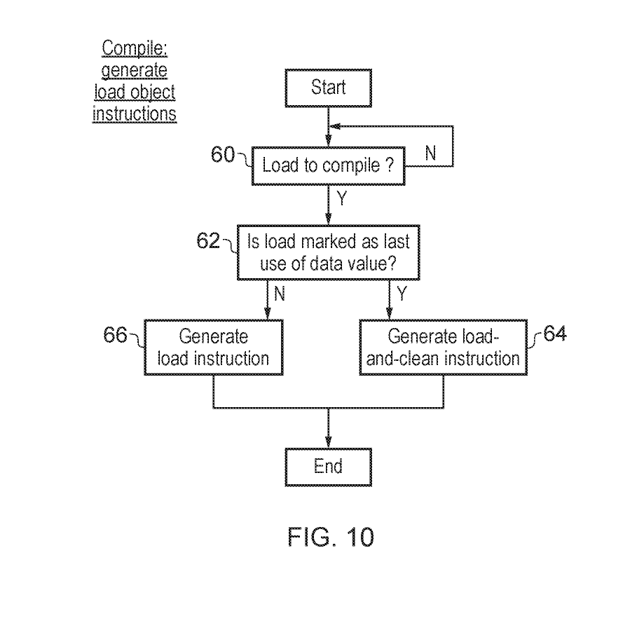

FIGS. 9 and 10 are flow diagrams schematically illustrating how a compiler of a source program to generate an object program may incorporate load-and-clean instructions into the object program. FIG. 9 illustrates how the compiler can search for the last use of the data value. At step 54 the compiler parses the source program to identify data values loaded from memory and used in the program. Step 56 searches front the end of the source code program towards to the beginning of the source code program to identify the last use of each data value loaded from memory. Step 58 marks the last use occurrences identified at step 56 within the program.

FIG. 10 illustrates how a compiler may generate load object instructions subsequent to the processing of FIG. 9. At step 60 the compiler waits until it reaches a point within the program being compiled at which it is required to compile a load operation. Step 62 determines whether or not that load operation is marked as the last use of a data value which is to be loaded. These are the uses which were marked in step 58 of FIG. 9. If the load is marked, then step 64 generates a load-and-clean instruction. If the load is not marked, then step 66 generates a standard load instruction.

Although illustrative embodiments have been described in detail herein with reference to the accompanying drawings, it is to be understood that the claims are not limited to those precise embodiments, and that various changes, additions and modifications can be effected therein by one skilled in the art without departing from the of the appended claims. For example, various combinations of the features of the dependent claims could he made with the features of the independent claims.

We claim:

1. Apparatus for processing data comprising:
a write-back cache having a plurality of cache lines;
processing circuitry to perform processing operations specified by program instructions; and
an instruction decoder to decode a load-and-clean instruction to generate control signals:
to control said processing circuitry to load data from a target portion of a target cache line; and
to control said write-back cache to mark as clean at least said target portion of said target cache line.

2. Apparatus as claimed in claim 1, wherein said target cache line comprises a plurality of portions, each of said plurality of portions having a dirty flag indicative of whether a respective portion has been written with data not yet written back to a memory.

3. Apparatus as claimed in claim 2, wherein write-back cache responds to said load-and-clean instruction to change a dirty flag for at least said target portion indicating that said target portion is dirty to indicate that said target portion is clean. Apparatus as claimed in claim 3, wherein write-back cache responds to said load-and-clean instruction:
to change a dirty flag for said target portion indicating that said target portion is dirty to indicate that said target portion is clean; and
to leave unchanged dirty flags for other portions of said target cache line.

5. Apparatus as claimed in claim 3, wherein write-back cache responds to said load-and-clean instruction:
to change a dirty flag for said target portion indicating that said target portion is dirty to indicate that said target portion is clean;
to change dirty flags for any further portions of said target cache line extending in a predetermined memory-address-order from said target portion to an end of said target cache line indicating that said further portions are dirty to indicate that said further portions are clean; and
to leave unchanged dirty flags for any other portions of said target cache line extending in an opposite predetermined memory-address-order from said target portion to an opposite end of said target cache line.

6. Apparatus as claimed in claim 3, wherein write-back cache responds to said load-and-clean instruction:
to change a dirty flag for said target portion indicating that said target portion is dirty to indicate that said target portion is clean;
if said target portion is at a predetermined end of said target cache line, then to change dirty flags for all portions of said target cache line indicating that said target portion is dirty to indicate that said portions of said target cache line are clean; and
if said target portion is not at said predetermined end of said target cache line, then to leave unchanged said dirty flags for other portions of said target cache line.

7. Apparatus as claimed in claim 5, comprising a stack memory region within said memory, said stack memory region having a direction of growth corresponding to said predetermined memory-address-order.

8. Apparatus as claimed in claim 1, wherein said target cache line comprises a plurality of portions and said target cache line has a dirty flag indicative of whether any of said plurality of portions has been written with data not yet written hack to a memory.

9. Apparatus as claimed in claim 8, wherein write-back cache responds to said load-and-clean instruction:
if said target portion is at a predetermined end of said target cache line, then to change a dirty flag for said target cache line indicating that said target cache line is dirty to indicate that said target cache line is clean; and
if said target portion is not at said predetermined end of said target cache line, then to leave unchanged said dirty flag for said target cache line.

10. Apparatus as claimed in claim 9, comprising a stack memory region within said memory, said stack memory region having a direction of growth corresponding to a predetermined memory-address-order and said predetermined end of said target cache line corresponds to a latest address in said direction of growth within said target cache line.

11. Apparatus as claimed in claim 1, wherein said target cache line remains valid and available for further access operations following execution of said load-and-clean program instruction.

12. Apparatus as claimed in claim 1, wherein said write-back cache comprises cache line eviction circuitry to control eviction of cache lines from said write-back cache and said cache line eviction circuitry is responsive to execution of load-and-clean program instructions.

13. Apparatus as claimed in claim 12, wherein said cache line eviction circuitry responds to execution of a load-and-clean program instruction that results in all portions of said target cache line marked as clean to promote said target cache line in an order for eviction.

14. Apparatus as claimed in claim 12, wherein said cache line eviction circuitry responds to execution of a load-and-clean program instruction to suppress updating of least-recently-used data associated with an access to said target cache line resulting from said load-and-clean program instruction.

15. Apparatus as claimed in claim 1, wherein said plurality of cache lines each have a valid flag indicative of whether a respective cache line contains any valid data.

16. Apparatus as claimed in claim 1, wherein said processing circuitry is programmed to access data within a temporary buffer.

17. Apparatus as claimed in claim 1, wherein said apparatus is a graphics processing unit.

18. Apparatus for processing data comprising:
write-back cache means for storing data, said write-back cache means having a plurality of cache lines;
processing means for performing processing operations specified by program instructions; and
instruction decoding means for decoding a load-and-clean instruction to generate control signals:
to control said processing means to load data from a target portion of a target cache line; and
to control said write-back cache means to mark as clean at least said target portion of said target cache line.

19. A method of processing data comprising:
storing data within a write-back cache having a plurality of cache lines;
perform processing operations specified by program instructions; and
decoding a load-and-clean instruction to generate control signals:
to control loading data from a target portion of a target cache line; and
to control marking as clean at least said target portion of said target cache line.

20. A method of compiling a source program to generate an object program comprising:
identifying a last use within said source program of a data value stored at a memory address;
if said source program specifies loading a target data value that is a last use of said target data value, then generating a corresponding load-and-clean instruction within said object program; and
if said source program specifies loading a target data value that is not a last use of said target data value, then generating a corresponding load instruction within said object program.
